(19) United States
(12) Patent Application Publication
(10) Pub. No.: US 2026/0286878 A1
(43) Pub. Date: Sep. 24, 2026

(54) EXHAUST AFTERTREATMENT SYSTEM

(71) Applicant: Donaldson Company, Inc., Bloomington, MN (US)

(72) Inventors: Naveen SRIDHARAN, Brussels (BE); Mariusz PIETRZYK, Agneaux (FR); Bavo FOLLON, Wijgmaal (BE); Francisco SILVA, Tienen (BE); Ajay Kumar MADDINENI, Nellore (IN); Rangesh PANDEY, Lucknow (IN); Ashish S, Bengaluru (IN); Niranjan GANDIGUDI, Karnataka (IN); Matthew SOLHEID, Bloomington, MN (US); Gopal KUMAR, Singrauli (IN)

(73) Assignee: Donaldson Company, Inc., Bloomington, MN (US)

(21) Appl. No.: 19/476,617

(22) PCT Filed: Apr. 15, 2024
(86) PCT No.: PCT/US2024/024555

§ 371 Date: Oct. 17, 2025

Related U.S. Application Data
(60) Provisional application No. 63/496,574, filed on Apr. 17, 2023.

(51) Int. Cl. F01N 3/20; B01D 53/94; B01F 25/431; F01N 3/28; F01N 13/00

(52) U.S. Cl. CPC F01N 13/0093; B01D 53/9431; B01D 53/944; B01D 53/9477; B01F 25/431; F01N 3/2066; F01N 3/2803; F01N 3/2892; B01D 2251/2067; B01D 2251/208; B01D 2257/404; B01D 2258/012; F01N 2240/20; F01N 2610/02; F01N 2610/1453

(57) ABSTRACT

In an exhaust conduit line extending downstream from an engine, an upstream exhaust aftertreatment arrangement and a downstream exhaust aftertreatment arrangement are disposed. Each of the upstream and downstream aftertreatment arrangements includes a respective mixer, a respective doser, and a respective catalytic substrate. The downstream aftertreatment arrangement is larger than the upstream aftertreatment arrangement. The combination of first aftertreatment and second aftertreatment arrangement is included to support requirement of ultra-low NOx conversions including the cold load collectives of vehicle operations. The mixer design is modular to be used both as a urea mixer and also as a hydrocarbon mixer across the exhaust aftertreatment system.

### CROSS REFERENCE TO RELATED APPLICATIONS

This application is a US national stage application of PCT International Patent Application No. PCT/US2024/024555, filed on Apr. 15, 2024, which claims the benefit of and priority to U.S. Provisional Patent Application No. 63/496,574, filed on Apr. 17, 2023, the disclosure of which is incorporated herein by reference in its entirety.

### BACKGROUND

Vehicles equipped with internal combustion engines (e.g., diesel engines) typically include exhaust systems that have aftertreatment components, such as selective catalytic reduction (SCR) catalyst devices, lean NOx catalyst devices, or lean NOx trap devices, to reduce the amount of undesirable gases, such as nitrogen oxides (NOx), in the exhaust. In order for these types of aftertreatment devices to work properly, an injector injects reactants (e.g., a reductant such as urea, ammonia, or hydrocarbons), into the exhaust gas. As the exhaust gas and reactants flow through the aftertreatment device, the exhaust gas and reactants convert the undesirable gases, such as NOx, into more acceptable gases, such as nitrogen and oxygen, However, the efficiency of the aftertreatment system depends upon how well the reactants are evaporated and how evenly the reactants are mixed with the exhaust gases. Therefore, a flow device that provides evaporation and mixing of exhaust gases and reactants is desirable. In case of hydrocarbon injection, the homogeneous mixing of the injected hydrocarbon and the exhaust gas is beneficial for optimal thermal management.

SCR exhaust treatment devices focus on the reduction of nitrogen oxides. In SCR systems, a reductant (e.g., aqueous urea solution) is dosed into the exhaust stream. The reductant reacts with nitrogen oxides while passing through an SCR catalyst to reduce the nitrogen oxides to nitrogen and water. When aqueous urea is used as a reductant, the aqueous urea is converted to ammonia which in turn reacts with the nitrogen oxides to covert the nitrogen oxides to nitrogen and water. Dosing, mixing and evaporation of aqueous urea solution can be challenging because the urea and by-products from the reaction of urea to ammonia can form deposits on the surfaces of the aftertreatment devices. Such deposits can accumulate over time and partially block or otherwise disturb effective exhaust flow through the aftertreatment device.

### SUMMARY

Aspects of the disclosure relate to an exhaust aftertreatment system including an exhaust conduit line extending downstream from an engine. In certain examples, the exhaust aftertreatment system includes a first NOx aftertreatment arrangement and a second NOx aftertreatment arrangement downstream of the first NOx aftertreatment arrangement. The first NOx aftertreatment arrangement is close coupled to the engine. The second NOx aftertreatment arrangement has a larger conversion efficiency than the first NOx aftertreatment arrangement. Each of the first and second NOx aftertreatment arrangements includes a respective mixer, a respective doser, and a respective catalytic converter (e.g., a Selective Catalytic Reduction (SCR) substrate).

In accordance with certain implementations, the mixer of the second aftertreatment arrangement is larger than the mixer of the first NOx aftertreatment arrangement.

In certain implementations, the spacing between the mixer and catalytic converter of the second NOx aftertreatment arrangement is larger than the spacing between the mixer and catalytic converter of the first NOx aftertreatment arrangement.

In certain implementations, the catalytic converter of the second NOx aftertreatment arrangement has a larger transverse cross-dimension (e.g., diameter) than the catalytic converter of the first NOx aftertreatment arrangement.

In certain implementations, the mixers of the first and second NOx aftertreatment arrangements each include a monolithic body forming a partition plate having a ring of louvers.

In certain examples, the ring of louvers surrounds a central opening.

In some examples, an annular flange extends downstream from a perimeter of the partition plate. In other examples, an annular flange extends upstream from a perimeter of the partition plate.

In certain implementations, the first NOx aftertreatment arrangement is located adjacent the turbocharger.

In certain implementations, a hydrocarbon injection arrangement is disposed upstream of a NOx aftertreatment arrangement.

In certain examples, the hydrocarbon injection arrangement is disposed between first and second NOx aftertreatment arrangements.

In certain examples, the hydrocarbon injection arrangement includes a diesel oxidation catalyst, a mixer, and a hydrocarbon doser mounting location. In certain examples, the mixer of the hydrocarbon injection arrangement includes a partition plate with a ring of louvers. In certain examples, the mixer of the hydrocarbon injection arrangement is the same as the mixer of the NOx aftertreatment arrangement.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram of an example tractor including an engine and exhaust system configured in accordance with the principles of the present disclosure;

FIG. 2 is a schematic diagram of an example exhaust aftertreatment system including an upstream aftertreatment arrangement and a downstream aftertreatment arrangement configured in accordance with the principles of the present disclosure, each aftertreatment arrangement including a mixer upstream of a doser;

FIG. 3 is a schematic diagram of an example exhaust aftertreatment system including an upstream aftertreatment arrangement and a downstream aftertreatment arrangement configured in accordance with the principles of the present disclosure, each aftertreatment arrangement including a doser upstream of a mixer;

FIG. 4 is a schematic diagram showing a comparison of an example first mixer of the upstream aftertreatment arrangement and an example second mixer of the downstream aftertreatment arrangement;

FIG. 5 is a perspective view showing an upstream side of an example mixer suitable for use in the upstream and/or downstream aftertreatment arrangement;

FIG. 6 is a perspective view showing the downstream side of the mixer of FIG. 5;

FIG. 7 is a side elevational view of the mixer of FIG. 6;

FIG. 8 is a schematic diagram of an example exhaust aftertreatment system including an upstream aftertreatment arrangement, a hydrocarbon injection arrangement, and a downstream aftertreatment arrangement configured in accordance with the principles of the present disclosure;

FIG. 9 is a perspective view showing an upstream side of another example mixer suitable for use in the upstream aftertreatment arrangement, the downstream aftertreatment arrangement, and/or the hydrocarbon injection arrangement; and

FIG. 10 is a perspective view showing the downstream side of the mixer of FIG. 9.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

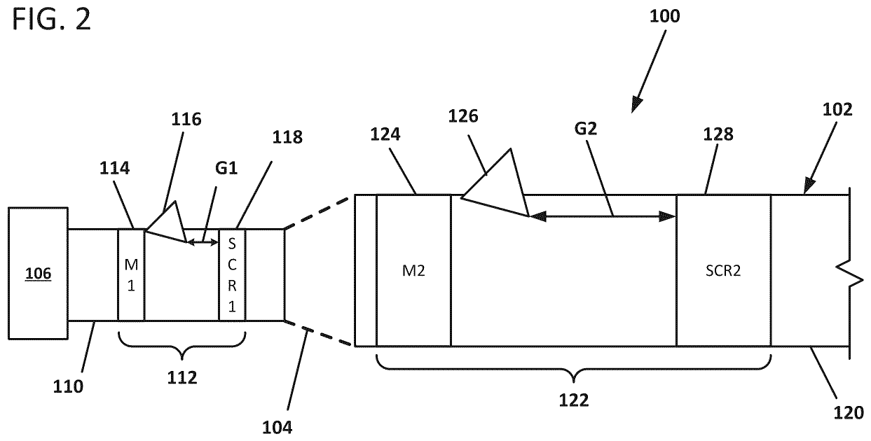

Aspects of the disclosure relate to an exhaust aftertreatment system 100 including an exhaust conduit line 102 extending downstream from an engine arrangement 106 to an exterior of a vehicle V (e.g., a tractor). In certain examples, the engine arrangement 106 includes an e turbocharger upstream of the exhaust system 100. The exhaust conduit line 102 is formed from one or more pipes 110, 120 coupled together (e.g., see FIG. 2). In certain examples, one or more of the pipes 120 can be disposed at an exterior of the vehicle V. In certain examples, one of the pipes 120 can be larger than another of the pipes 110. The pipes 110, 120 of different size can be coupled together at a transition 104 (e.g., using a funnel shaped pipe, using an adapter, using a housing, etc.).

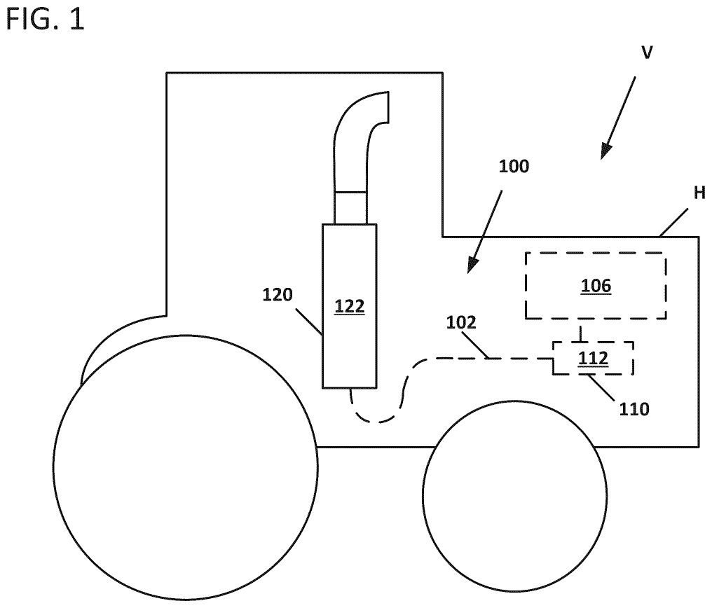

In certain implementations, the first aftertreatment arrangement 112 is disposed within the first pipe 110 and the second aftertreatment arrangement 122 is disposed within the second pipe 120. In certain examples, the second pipe 120 is located adjacent the first pipe 110. In other implementations, however, the first and second aftertreatment arrangements 112, 122 can be disposed in non-adjacent pipes (i.e., can be separated by one or more pipes) or can be disposed within a common pipe. In certain examples, the first pipe 110 can be disposed within a body of a vehicle V (e.g., under the hood H of the vehicle) and the second pipe 120 can be disposed external of the body of the vehicle V. In an example, the first pipe 110 is located under the hood H of the vehicle V and is smaller than the pipe 120 located external of the hood H or even external of the vehicle V (e.g., see FIG. 1).

In certain implementations, the exhaust aftertreatment system 100 includes a first aftertreatment arrangement 112 (e.g., an upstream aftertreatment arrangement) and a second aftertreatment arrangement 122 (e.g., a downstream aftertreatment arrangement) located downstream of the first aftertreatment arrangement 112. The first aftertreatment arrangement 112 is close coupled to the engine 106 to reach a temperature sufficient to support NOx conversion at the first aftertreatment arrangement 112 within 100 seconds (e.g., 100 seconds, 95 seconds, 90 seconds, 80 seconds, 70 seconds, 60 seconds, etc.) of the engine starting. Temperatures supporting NOx conversion begin in the range of about 180-200 degrees Fahrenheit (i.e., about 82-93 degrees Celsius). Accordingly, the close coupled aftertreatment arrangement 112 supports at least some NOx conversions during the cold phase of the vehicle operation. In certain examples, the first aftertreatment arrangement 112 is disposed within the first pipe 110 located within the vehicle V.

In certain implementations, the second aftertreatment arrangement 122 is sufficiently spaced from the engine that the thermal profile of the exhaust system support NOx conversion at the second aftertreatment arrangement 122 after about 200 seconds or more (e.g., 200 seconds, 250 seconds, 300 seconds, 350 seconds, 400 seconds, etc.) after the start of the engine. In certain examples, the second aftertreatment arrangement 122 is disposed within the second pipe 120 located external of the hood H or vehicle V. Because the second aftertreatment arrangement 122 is external of the hood H or vehicle V, the size of the second aftertreatment arrangement 122 is not limited by the surrounding environment of the vehicle V (e.g., the engine under the hood H). Accordingly, the second aftertreatment arrangement 122 can be formed larger than the first aftertreatment arrangement 112, thereby allowing for more NOx conversion at a time compared to the first aftertreatment arrangement 112 once conversions supporting temperatures are reached.

Therefore, the first aftertreatment arrangement 112 begins removing NOx from the exhaust flow earlier in the vehicle operations than the second aftertreatment arrangement 122 and the second aftertreatment arrangement 122 removes a greater amount of NOx per time period than the first aftertreatment arrangement 112. Accordingly, a greater amount of NOx can be removed from the exhaust flow using both aftertreatment arrangements 112, 122 than with either of the aftertreatment arrangements 112, 122 individually.

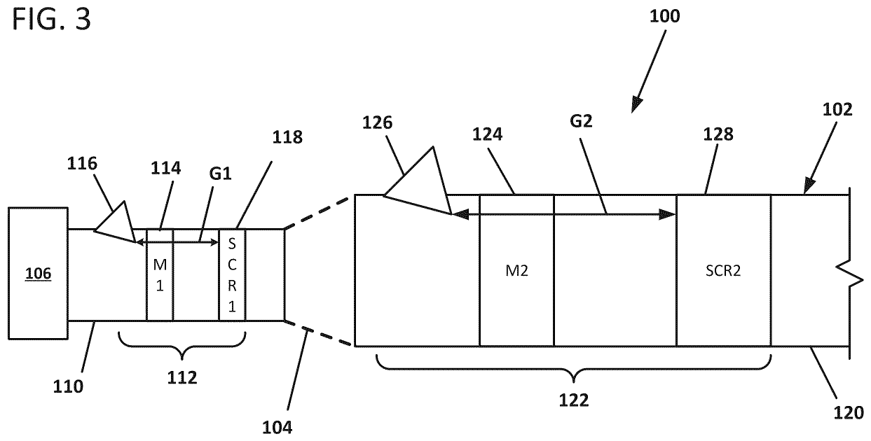

Referring to FIGS. 2 and 3, each of the first and second aftertreatment arrangements 112, 122 includes a respective mixer 114, 124, a respective doser 116, 126 to dispense reactant such as urea, and a respective catalytic converter 118, 128 (e.g., an SCR substrate). In some implementations, the doser 116, 126 is disposed between the mixer 114, 124 and the catalytic substrate 118, 128, respectively (e.g., see FIG. 2). Positioning the mixer 114, 124 upstream of the doser 116, 126 mitigates build up on the mixer 114, 124 because the exhaust is carrying the reactant expelled by the doser 116, 126 away from the mixer 114, 124. In certain examples, the doser 116, 126 is oriented to expel reactant (e.g., urea) away from the respective mixer 114, 124, respectively. In certain examples the doser 116, 126 is oriented to expel the reactant towards the catalytic substrate 118, 128, respectively. In other implementations, the doser 116, 126 can be disposed upstream of the mixer 114, 124, respectively (e.g., see FIG. 3).

In accordance with certain aspects of the disclosure, the second aftertreatment arrangement 122 has a higher weightage of conversion efficiency than the first aftertreatment arrangement 112. Accordingly, the first aftertreatment arrangement 112 generates an initial drop in NOx by a first amount and the second aftertreatment arrangement 122 generates a subsequent drop in NOx by a second amount that is greater than the first amount.

In certain implementations, a distance G2 extending between the second doser 126 and the second catalytic converter 128 is longer than a distance G1 extending between the first doser 116 and the first catalytic converter 118 (e.g., see FIGS. 2 and 3). Accordingly, the reactant tends to mix more uniformly with the exhaust before reaching the second catalytic substrate 128 compared to reactant traveling towards the first catalytic substrate 118. This enhanced mixing may lead to better performance of the second catalytic substrate 128 compared to the first catalytic substrate 118. In certain examples, the second distance G2 is at least double the first distance G1. In certain examples, the second distance G2 is at least triple the first distance G1. In certain examples, the second distance G2 is larger than the first distance G1 by a factor of 10.

In certain implementations, the second mixer 124 is larger than the first mixer 114. The first mixer 114 has a first length T1 extending along the exhaust conduit line 102 and a first transverse cross-dimension (e.g., diameter) D1 extending transverse to the first length T1. The second mixer 124 has a second length T2 extending along the exhaust conduit line 102 and a second transverse cross-dimension D2 extending transverse to the second length T2.

In some implementations, the second transverse cross-dimension D2 is larger than the first transverse cross-dimension D1. For example, the second transverse cross-dimension D2 may be at least 1.5 times the size of the first transverse cross-dimension D1. In certain examples, the second transverse cross-dimension D2 may be at least 2 times the size of the first transverse cross-dimension D1. In other implementations, the first and second transverse cross-dimensions D1, D2 may be the same. In certain examples, the first transverse cross-dimension DI may range between 2.5 inches and 13 inches or between 2.5 inches and 6 inches. In various examples, the first transverse cross-dimension DI can be 2.5 inches, 3 inches, 4 inches, 5 inches, 6 inches, etc. In certain examples, the second transverse cross-dimension D2 may range between 5 inches and 13 inches. In various examples, the second transverse cross-dimension D2 can be 5 inches, 6 inches, 8 inches, 10 inches, 13 inches, etc.

In certain implementations, the second substrate 128 has an increased differential pressure (e.g., backpressure) compared to the first substrate 118. In certain examples, the second substrate 128 is larger than the first substrate 118. For example, a length of the second substrate 128 may be longer than the length of the first substrate 118. In certain examples, a transverse cross-dimension of the second substrate 128 may be larger than the transverse cross-dimension of the first substrate 118. In certain examples, cell density of the second substrate 128 may be larger than a cell density of the first substrate 118.

In certain implementations, the doser 116, 126 can be disposed upstream of the mixer 114, 124, respectively. In such implementations, the distance G1, G2 between the doser 116, 126 and the substrate 118, 128 is at least double the distance between the doser 116, 126 and the mixer 114, 124, respectively. In certain examples, the distance G1, G2 between the doser 116, 126 and the substrate 118, 128 is at least triple the distance between the doser 116, 126 and the mixer 114, 124, respectively. In certain examples, the distance G1, G2 between the doser 116, 126 and the substrate 118, 128 is at least quadruple the distance between the doser 116, 126 and the mixer 114, 124, respectively.

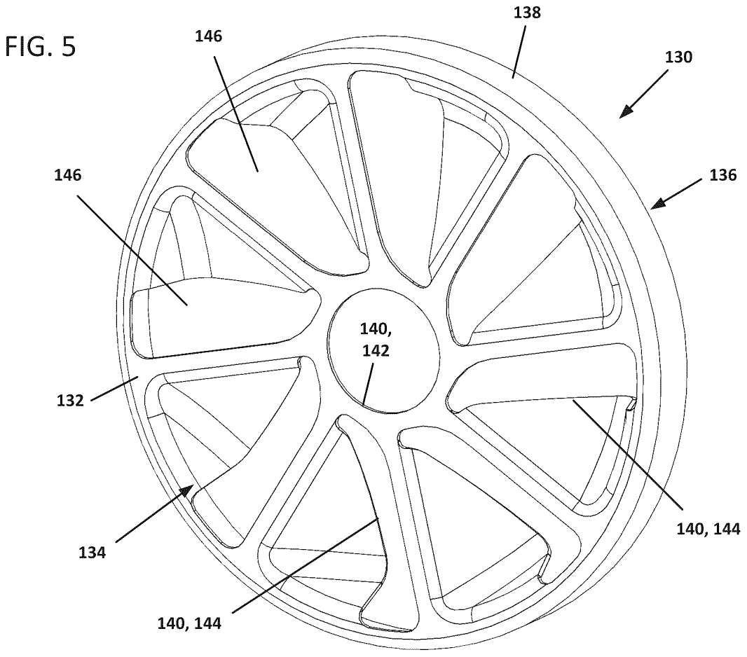

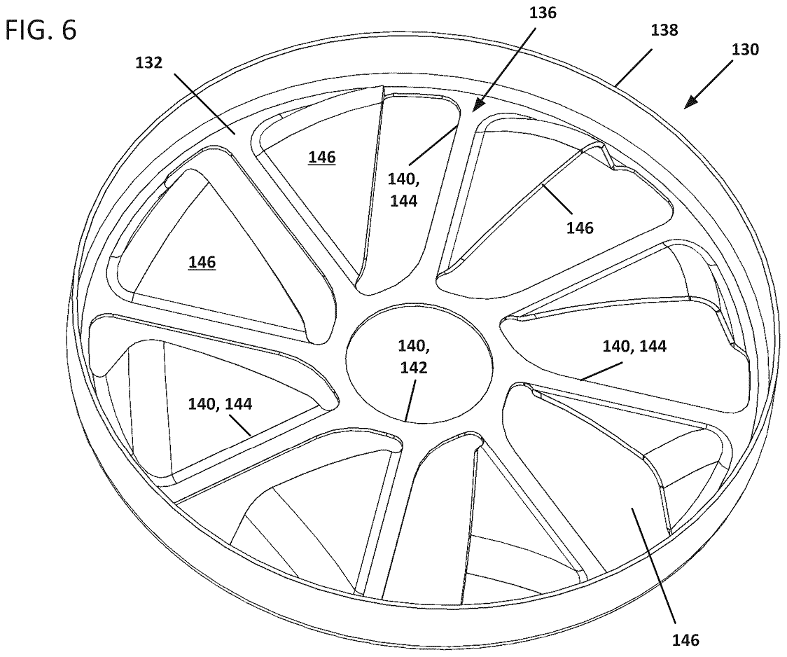

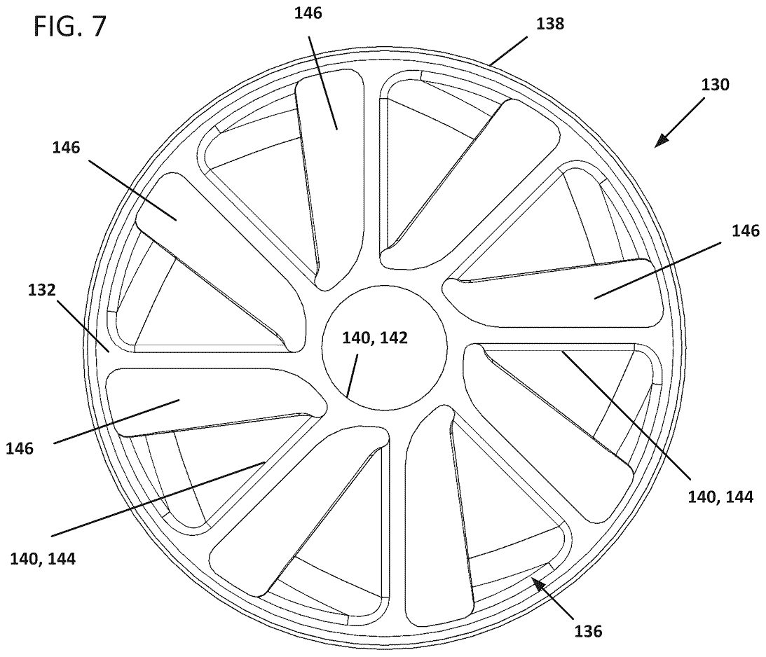

FIGS. 5-7 illustrate an example implementation of a mixing plate 130 suitable for use with the mixer 114, 124 in either the first aftertreatment arrangement 112 or the second aftertreatment arrangement 122. In some implementations, the mixing plate 130 is used alone to form a mixer 114, 124. In other implementations, the mixer 114, 124 is formed from two of the mixing plates 130 being placed back-to-back to form a mixing conduit. In certain examples, the back-to-back mixing plates 130 are welded, fastened, friction fit, or otherwise coupled to each other. In certain examples, the back-to-back mixing plates 130 are identical to each other. In certain examples, the exhaust is rotated in one direction by passing through a first of the mixing plates 130 of the mixing conduit and is rotated in an opposite direction by passing through a second of the mixing plates 130 of the mixing conduit.

The mixing plate 130 includes a partition plate 132 that extends across a transverse cross-dimension (e.g., a diameter) of the pipe 110, 120 of the exhaust conduit line 102. The partition plate 132 has an upstream side 134 facing upstream of the mixing plate 130 and a downstream side 136 facing downstream of the mixing plate 130. In certain examples, the downstream side 136 is opposite the upstream side 134. In some examples, the partition plate 132 has a generally planar surface defining the upstream side 134. In other examples, the surface defining the upstream side 134 can be contoured.

An annular flange 138 extend outwardly along the exhaust conduit line 102 from the perimeter of the partition plate 132. In certain examples, the annular flange 138 facilitates mounting the mixing plate 130 to the surrounding pipe of the exhaust conduit line 102. In certain examples, the annular flanges 138 of back-to-back mixing plates 130 secure together to form the mixing conduit.

In certain implementations, the partition plate 132 defines one or more openings 140 extending between the upstream side 134 and the downstream side 136. In some implementations, the openings 140 of the partition plate 132 include a central opening 142. In other implementations, the openings 140 include a plurality of openings 142 disposed at a central region of the partition plate 132. In certain implementations, the openings 140 of the partition plate 132 also include a ring of openings 144 around a central region of the partition plate 132. In various examples, the openings 144 can include four openings, five openings, six openings, seven openings, or eight openings. In certain examples, the ring of openings 144 surrounds the central opening 142. In other implementations, other configurations of openings 140 are possible.

In certain implementations louvers 146 are disposed at the openings 144 of the ring. In certain example, the louvers 146 are configured to add a rotational spin (e.g., a swirl) to the exhaust flow passing through the openings 144. In some examples, the louvers 146 are formed from bent or contoured sections of the partition plate 132. In other implementations, the louvers 146 are otherwise monolithically formed with the partition plate 132 (e.g., by being molded or cast as a single piece). In still other implementations, the louvers 146 can be welded or otherwise coupled to the partition plate 132. In the depicted example, the louvers 146 are contoured so that each louver 146 forms a hood over a portion of the respective opening 144. In certain examples, the louvers 146 and openings 142, 144 cooperate to from an openness ratio of the mixing plate 130 of between 30% and 50%. In certain examples, the openness ratio of the mixing plate 130 is between 35% and 45%; between 35% and 40%, between 30% and 40%, or between 30% and 35%, In an example, the openness ratio is 35%, 36%, 37%, 38%, 39%, or 40%. In other examples, the louvers 146 can be planar or otherwise shaped.

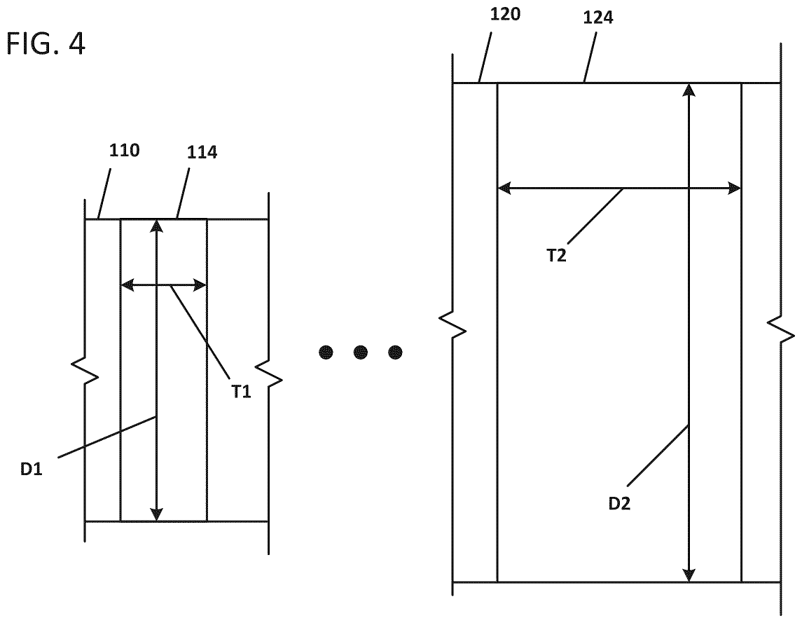

The design of the mixer 130 shown in FIGS. 3-5 can be used with the first mixer 114 of the first aftertreatment arrangement 112 and/or with the second mixer 124 of the second aftertreatment arrangement 122. In some implementations, the second mixer 124 is identical to the first mixer 114. In other implementations, the second mixer 124 is identical to the first mixer 114 except for size. In certain examples, the second mixer 124 is a scaled-up version of the first mixer 114. In other examples, however, the second mixer 124 can differ (e.g., in the configuration of openings 140 through the partition plate 132). In still other implementations, the second mixer 124 can be a different style mixer from the first mixer 114. For example, one of the mixers 114, 124 can be an impact type mixer while the other is an axial mixer, a twist mixer, or another style mixer.

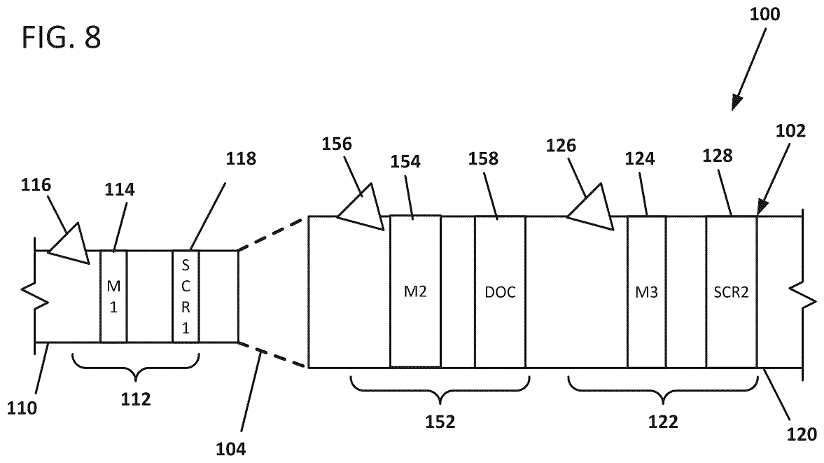

Referring now to FIG. 8, certain implementations of the exhaust system 100 may include a hydrocarbon injection arrangement 152 configured to heat exhaust gas upstream of a NOx aftertreatment arrangement (e.g., the second aftertreatment arrangement 122). The hydrocarbon injection arrangement 152 injects hydrocarbons (e.g., diesel) into the exhaust flow upstream of a diesel oxidation catalyst (DOC) 158. An exothermic catalytic reaction within the DOC 158 burns off the diesel within the DOC 158, thereby generating heat. The heated exhaust flow then proceeds to the NOx aftertreatment arrangement (e.g., the second aftertreatment arrangement 122). Heating the exhaust using the hydrocarbon injection arrangement 152 spurs earlier NOx conversion at the downstream NOx aftertreatment arrangement 122. In some implementations, the hydrocarbon injection arrangement 152 is disposed between the upstream and downstream aftertreatment arrangements 112, 122. In other implementations, however, the hydrocarbon injection arrangement 152 is used with only an aftertreatment arrangement disposed external of the vehicle hood H.

As shown in FIG. 8, the hydrocarbon injection arrangement 152 includes a hydrocarbon injector 156 upstream of the DOC 158. In certain implementations, the hydrocarbon injection arrangement 152 includes a mixer 154. The mixer creates turbulence to enhance homogeneity of the injected hydrocarbons with the exhaust gas before the hydrocarbons reach the DOC 158. In the depicted example, the mixer 154 may be disposed between the hydrocarbon injector 156 and the DOC 158. In other examples, however, the mixer 154 may be disposed upstream of the hydrocarbon injector 156. In certain implementations, the mixer 154 may be the same as the mixer 114 of the first aftertreatment arrangement 112. In certain implementations, the mixer 154 may be the same as the mixer 124 of the second aftertreatment arrangement 122. In certain implementations, the mixer 154 may have the same shape as, but a different size from, the mixer 114, 124 of one of the aftertreatment arrangements 112, 122. In certain implementations, the mixer 154 may include the mixing plate 130 of FIGS. 5-7.

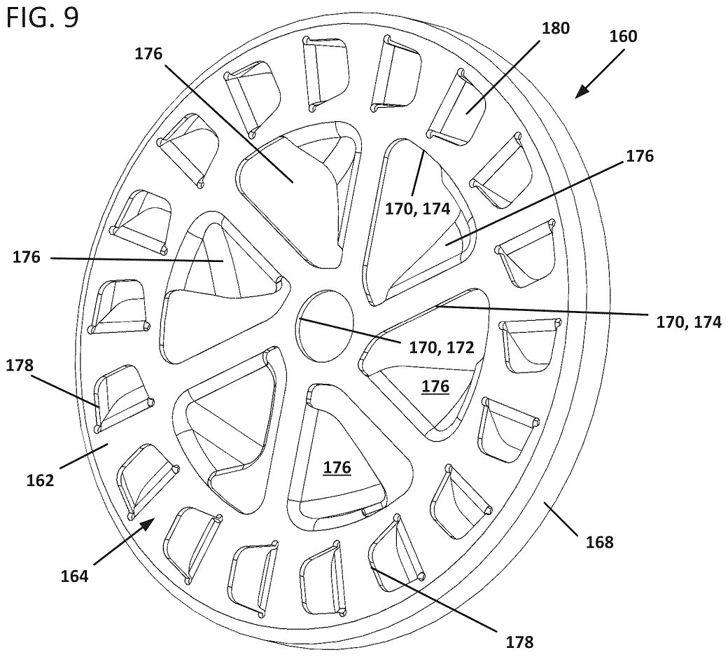

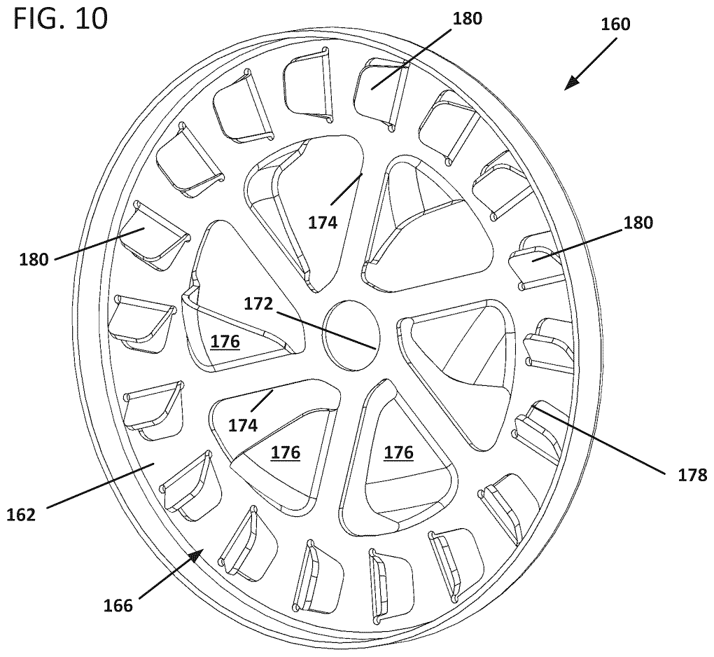

FIGS. 9-10 illustrate an example implementation of a mixing plate 160 suitable for use with the mixer 114, 124, 154 in either the first aftertreatment arrangement 112, the second aftertreatment arrangement 122, or the hydrocarbon injection arrangement 152. In some implementations, the mixing plate 160 is used alone to form a mixer 114, 124, 154. In other implementations, the mixer 114, 124, 154 is formed from two of the mixing plates 160 being placed back-to-back to form a mixing conduit. In certain examples, the back-to-back mixing plates 160 are welded, fastened, friction fit, or otherwise coupled to each other. In certain examples, the back-to-back mixing plates 160 are identical to each other. In certain examples, the exhaust is rotated in one direction by passing through a first of the mixing plates 160 of the mixing conduit and is rotated in an opposite direction by passing through a second of the mixing plates 160 of the mixing conduit.

The mixing plate 160 includes a partition plate 162 that extends across a transverse cross-dimension (e.g., a diameter) of the pipe 110, 120 of the exhaust conduit line 102. The partition plate 162 has an upstream side 164 facing upstream of the mixing plate 130 and a downstream side 166 facing downstream of the mixing plate 160. In certain examples, the downstream side 166 is opposite the upstream side 164. In some examples, the partition plate 162 has a generally planar surface defining the upstream side 164. In other examples, the surface defining the upstream side 164 can be contoured.

An annular flange 168 extend outwardly along the exhaust conduit line 102 from the perimeter of the partition plate 162. In certain examples, the annular flange 168 facilitates mounting the mixing plate 160 to the surrounding pipe of the exhaust conduit line 102. In certain examples, the annular flanges 168 of back-to-back mixing plates 160 secure together to form the mixing conduit.

In certain implementations, the partition plate 162 defines one or more openings 170 extending between the upstream side 164 and the downstream side 166. In some implementations, the openings 170 of the partition plate 132 include a central opening 172. In other implementations, the openings 170 include a plurality of openings disposed at a central region of the partition plate 162. In certain implementations, the openings 170 of the partition plate 162 also include a ring of openings 174 around a central region of the partition plate 162. In various examples, the openings 174 can include four openings, five openings, six openings, seven openings, or eight openings. In certain examples, the ring of openings 174 surrounds the central opening 172. In certain implementations, the openings 170 of the partition plate 162 also includes a second ring of openings 178 that surround the openings 174. In certain examples, the second ring includes more openings 178 than the first ring of openings 174. In certain examples, the openings 178 of the second ring are smaller than the openings 174 of the first ring. In other implementations, other configurations of openings 170 are possible.

In certain implementations louvers 176 are disposed at the openings 174 of the first ring. In certain example, the louvers 176 are configured to add a rotational spin (e.g., a swirl) to the exhaust flow passing through the openings 174 of the first ring. In some examples, the louvers 176 are formed from bent or contoured sections of the partition plate 162. In other implementations, the louvers 176 are otherwise monolithically formed with the partition plate 162 (e.g., by being molded or cast as a single piece). In still other implementations, the louvers 176 can be welded or otherwise coupled to the partition plate 162. In the depicted example, the louvers 176 are contoured so that each louver 176 forms a hood over a portion of the respective opening 174. In certain examples, the louvers 176 and openings 172, 174 cooperate to from an openness ratio of the mixing plate 130 of between 30% and 50%. In certain examples, the openness ratio of the mixing plate 130 is between 35% and 45%; between 35% and 40%, between 30% and 40%, or between 30% and 35%. In an example, the openness ratio is 35%, 36%, 37%, 38%, 39%, or 40%. In other examples, the louvers 176 can be planar or otherwise shaped.

In certain implementations, the openings 178 of the second ring also may include louvers 180. In certain examples, the louvers 180 of the second ring of openings 178 direct exhaust flow in an opposite rotational direction compared to the louvers 176 of the first ring of openings 174. Accordingly, the louvers 180 provide a counter swirl to inhibit reactant carried by the exhaust from impacting the inner surfaces of the exhaust conduit line 102. In certain examples, the louvers 180 include planar tabs extending outwardly from the openings 178. In certain examples, the louvers 180 are stamped out of the partition plate 162 to form the openings 178.

The design of the mixer 130 shown in FIGS. 3-5 and/or of the mixer 160 shown in FIGS. 9-10 can be used as the first mixer 114 of the first aftertreatment arrangement 112 and/or with the second mixer 124 of the second aftertreatment arrangement 122. In some implementations, the second mixer 124 is identical to the first mixer 114. In other implementations, the second mixer 124 is identical to the first mixer 114 except for size. In certain examples, the second mixer 124 is a scaled-up version of the first mixer 114. In other examples, however, the second mixer 124 can differ (e.g., in the configuration of openings 140 through the partition plate 132). In still other implementations, the second mixer 124 can be a different style mixer from the first mixer 114. For example, one of the mixers 114, 124 can be an impact type mixer while the other is an axial mixer, a twist mixer, or another style mixer.

### Aspects of the Disclosure

Aspect 1. An exhaust aftertreatment system for a vehicle comprising:
an exhaust conduit line extending from an interior of the vehicle to an exterior of the vehicle;
a first aftertreatment arrangement disposed along the exhaust conduit line within the interior of the vehicle, the first aftertreatment arrangement including a first mixer, a first mounting location, and a first catalytic substrate, the first mounting location being configured to receive a first doser and to position a tip of the first doser at a first predetermined location along the exhaust conduit line, the first catalytic substrate being located a first distance away from the first predetermined location; and
a second aftertreatment arrangement disposed along the exhaust conduit line downstream of the first aftertreatment arrangement and external of the vehicle, the second aftertreatment arrangement including a second mixer, a second mounting location, and a second catalytic substrate, the second mounting location being configured to receive a second doser and to position a tip of the second doser at a second predetermined location along the exhaust conduit line, and the second catalytic substrate being located a second distance away from the second predetermined location, the second distance being larger than the first distance.

Aspect 2. The exhaust aftertreatment system of aspect 1, wherein the second distance is at least double the first distance.

Aspect 3. The exhaust aftertreatment system of aspect 1, wherein the second distance is larger than the first distance by a factor of 10.

Aspect 4. The exhaust aftertreatment system of any of aspects 1-3, wherein the first mixer is a monolithically formed impact mixer.

Aspect 5. The exhaust aftertreatment system of any of aspects 1-4, wherein the second mixer is a monolithically formed impact mixer.

Aspect 6. The exhaust aftertreatment system of any of aspects 1-5, wherein the second mixer is larger than the first mixer.

Aspect 7. The exhaust aftertreatment system of aspect 6, wherein a transverse cross-dimension of the second mixer is larger than a transverse cross-dimension of the first mixer.

Aspect 8. The exhaust aftertreatment system of any of aspects 1-7, wherein the first mixer includes a partition plate and an annular flange extending downstream from a perimeter of the partition plate, the partition plate defines a plurality of openings extending between an upstream side of the partition plate and a downstream side of the partition plate.

Aspect 9. The exhaust aftertreatment system of aspect 8, wherein the partition plate includes louvers extending downstream from at least some of the openings.

Aspect 10. The exhaust aftertreatment system of aspect 9, wherein the louvers form a ring around a central one of the openings.

Aspect 11. The exhaust aftertreatment system of any of claims 8-10, wherein the openings include an inner ring of openings and an outer ring of openings, wherein first louvers are disposed at the inner ring of openings and second louvers are disposed at the outer ring of openings, the second louvers directing flow in a different rotational direction from the first louvers.

Aspect 12. The exhaust aftertreatment system of any of aspects 1-11, wherein the first mounting location is disposed between the first mixer and the first catalytic substrate.

Aspect 13. The exhaust aftertreatment system of any of aspects 1-12, wherein the second mounting location is disposed between the second mixer and the second catalytic substrate.

Aspect 14. The exhaust aftertreatment system of any of aspects 1-13, further comprising a hydrocarbon injection arrangement disposed along the conduit line between the first and second aftertreatment arrangements, the hydrocarbon injection arrangement including a mixer and a diesel oxidation catalyst.

Aspect 15. The exhaust aftertreatment system of any of aspects 1-14, wherein the first aftertreatment arrangement is sufficiently closely coupled to an engine of the vehicle to reach a temperature of at least 180 degrees in less than 100 seconds while the second aftertreatment arrangement is located sufficiently far from the engine to take at least 200 seconds to reach a temperature of at least 180 degrees.

Aspect 16. The exhaust aftertreatment system of any of aspects 1-15, further comprising:
the first doser mounted at the first mounting location; and
the second doser mounted at the second mounting location.

Aspect 17. An exhaust aftertreatment system for an engine system comprising: an exhaust conduit line;
a first aftertreatment arrangement disposed along the exhaust conduit line, the first aftertreatment arrangement including a first mixer, a first doser, and a first catalytic substrate, the first mixer having a first transverse cross-dimension; and
a second aftertreatment arrangement disposed along the exhaust conduit line downstream of the first aftertreatment arrangement, the second aftertreatment arrangement including a second mixer, a second doser, and a second catalytic substrate, and the second mixer having a second transverse cross-dimension, the second transverse cross-dimension being larger than the first transverse cross-dimension;
wherein at least one of the first and second mixers includes a partition plate and an annular flange extending downstream from a perimeter of the partition plate, the partition plate defines a plurality of openings extending between an upstream side of the partition plate and a downstream side of the partition plate, and the partition plate including louvers extending downstream from at least some of the openings, and wherein the louvers form a ring around a central one of the openings.

Aspect 18. The exhaust aftertreatment system of aspect 17, wherein the second transverse cross-dimension is larger than the first transverse cross-dimension by a factor of 1.5.

Aspect 19. The exhaust aftertreatment system of any of aspects 17 and 18, wherein the first mixer is a monolithically formed impact mixer.

Aspect 20. The exhaust aftertreatment system of any of aspects 17-19, wherein the second mixer is a monolithically formed impact mixer.

Aspect 21. The exhaust aftertreatment system of any of aspects 17-20, the second mixer is located further from the second catalytic substrate than the first mixer is located from the first catalytic substrate.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. An exhaust aftertreatment system for a vehicle comprising:
an exhaust conduit line extending from an interior of the vehicle to an exterior of the vehicle;
a first aftertreatment arrangement disposed along the exhaust conduit line within the interior of the vehicle, the first aftertreatment arrangement including a first mixer, a first mounting location, and a first catalytic substrate, the first mounting location being configured to receive a first doser and to position a tip of the first doser at a first predetermined location along the exhaust conduit line, the first catalytic substrate being located a first distance away from the first predetermined location; and
a second aftertreatment arrangement disposed along the exhaust conduit line downstream of the first aftertreatment arrangement and external of the vehicle, the second aftertreatment arrangement including a second mixer, a second mounting location, and a second catalytic substrate, the second mounting location being configured to receive a second doser and to position a tip of the second doser at a second predetermined location along the exhaust conduit line, and the second catalytic substrate being located a second distance away from the second predetermined location, the second distance being larger than the first distance.

2. The exhaust aftertreatment system of claim 1, wherein the second distance is at least double the first distance.

3. (canceled)

4. The exhaust aftertreatment system of claim 1,
wherein the first mixer is a monolithically formed impact mixer.

5. The exhaust aftertreatment system of claim 1, wherein the second mixer is a monolithically formed impact mixer.

6. The exhaust aftertreatment system of claim 1, wherein the second mixer is larger than the first mixer.

7. The exhaust aftertreatment system of claim 6, wherein a transverse cross-dimension of the second mixer is larger than a transverse cross-dimension of the first mixer.

8. The exhaust aftertreatment system of claim 1, wherein the first mixer includes a partition plate and an annular flange extending downstream from a perimeter of the partition plate, the partition plate defines a plurality of openings extending between an upstream side of the partition plate and a downstream side of the partition plate.

9. The exhaust aftertreatment system of claim 8, wherein the partition plate includes louvers extending downstream from at least some of the openings.

10. The exhaust aftertreatment system of claim 9, wherein the louvers form a ring around a central one of the openings.

11. The exhaust aftertreatment system of claim 8, wherein the openings include an inner ring of openings and an outer ring of openings, wherein first louvers are disposed at the inner ring of openings and second louvers are disposed at the outer ring of openings, the second louvers directing flow in a different rotational direction from the first louvers.

12. The exhaust aftertreatment system of claim 1, wherein the first mounting location is disposed between the first mixer and the first catalytic substrate.

13. The exhaust aftertreatment system of claim 1, wherein the second mounting location is disposed between the second mixer and the second catalytic substrate.

14. The exhaust aftertreatment system of claim 1, further comprising a hydrocarbon injection arrangement disposed along the conduit line between the first and second aftertreatment arrangements, the hydrocarbon injection arrangement including a mixer and a diesel oxidation catalyst.

15. The exhaust aftertreatment system of claim 1, wherein the first aftertreatment arrangement is sufficiently closely coupled to an engine of the vehicle to reach a temperature of at least 180 degrees in less than 100 seconds while the second aftertreatment arrangement is located sufficiently far from the engine to take at least 200 seconds to reach a temperature of at least 180 degrees.

16. The exhaust aftertreatment system of claim 1, further comprising:
the first doser mounted at the first mounting location; and
the second doser mounted at the second mounting location.

17. An exhaust aftertreatment system for an engine system comprising:
an exhaust conduit line;
a first aftertreatment arrangement disposed along the exhaust conduit line, the first aftertreatment arrangement including a first mixer, a first doser, and a first catalytic substrate, the first mixer having a first transverse cross-dimension; and
a second aftertreatment arrangement disposed along the exhaust conduit line downstream of the first aftertreatment arrangement, the second aftertreatment arrangement including a second mixer, a second doser, and a second catalytic substrate, and the second mixer having a second transverse cross-dimension, the second transverse cross-dimension being larger than the first transverse cross-dimension;
wherein at least one of the first and second mixers includes a partition plate and an annular flange extending downstream from a perimeter of the partition plate, the partition plate defines a plurality of openings extending between an upstream side of the partition plate and a downstream side of the partition plate, and the partition plate including louvers extending downstream from at least some of the openings, and wherein the louvers form a ring around a central one of the openings.

18. The exhaust aftertreatment system of claim 17, wherein the second transverse cross-dimension is larger than the first transverse cross-dimension by a factor of 1.5.

19. The exhaust aftertreatment system of claim 17, wherein the first mixer is a monolithically formed impact mixer.

20. The exhaust aftertreatment system of claim 17, wherein the second mixer is a monolithically formed impact mixer.

21. The exhaust aftertreatment system of claim 17, the second mixer is located further from the second catalytic substrate than the first mixer is located from the first catalytic substrate.
